(19) United States
(12) Patent Application Publication
(10) Pub. No.: US 2025/0392858 A1
(43) Pub. Date: Dec. 25, 2025

(54) IN-VEHICLE SPEAKER SYSTEM

(71) Applicant: HARMAN BECKER AUTOMOTIVE SYSTEMS GMBH, Karlsbad (DE)

(72) Inventor: Daniel BRACHT, Karlsruhe (DE)

(73) Assignee: HARMAN BECKER AUTOMOTIVE SYSTEMS GMBH, Karlsbad (DE)

(21) Appl. No.: 19/246,199

(22) Filed: Jun. 23, 2025

(30) Foreign Application Priority Data
Jun. 24, 2024 (EP) 24184135.2

(51) Int. Cl. H04R 1/32; G08B 6/00

(52) U.S. Cl. CPC H04R 1/323; G08B 6/00; H04R 2499/13

(57) ABSTRACT

The disclosure relates to an in-vehicle speaker system comprising at least one first low frequency speaker arranged to face in a first direction; and at least one second low frequency speaker arranged to face in a second direction, wherein the first and second speakers are mechanically coupled to a vehicle seat to generate tactile feedback to a user in the seat, and wherein the first and second directions are different from one another, in particular opposite to one another, the in-vehicle speaker system further comprising a controller to control input voltages of the first and second speakers relative to one another, thereby to adjust the amount of the tactile feedback. The disclosure further relates to a method of providing tactile feedback in a vehicle seat.

### CROSS-REFERENCE TO RELATED APPLICATIONS

This application claims priority to EP Application Serial No. 24184135.2 filed Jun. 24, 2024, the disclosure of which is hereby incorporated in its entirety by reference herein.

### TECHNICAL FIELD

The present disclosure relates to an in-vehicle speaker system. In particular, the present disclosure relates to an in-vehicle speaker system including low frequency speakers coupled to a vehicle structure and facing in different directions to enable controlling an amount of tactile feedback to a listener in the vehicle.

### BACKGROUND

Known vehicle audio systems include a plurality of loudspeakers arranged at different locations in the vehicle interior. Such systems may include a separate woofer for low frequency audio signals to improve the audio quality. Depending on the volume, sound from a woofer may have a tactile effect, for example through vibrations in a vehicle seat. Such tactile effect may enhance the audio experience by making the audio appear more powerful. However, this is subjective, and while some listeners may prefer tactile feedback, others may find this annoying.

The present disclosure aims to provide a system and method that enables providing an adjustable amount of tactile feedback in an in-vehicle audio system.

### SUMMARY

The present invention is defined, by at least, the independent claims. Selected optional features are defined in the dependent claims and also by one or more aspects of the present disclosure.

The present disclosure relates to an in-vehicle speaker system that enables a user to adjust the amount of tactile feedback. The in-vehicle speaker system includes speakers that are mechanically coupled to a structure of the vehicle, for example a vehicle seat. Vibrations caused by the speaker are transmitted into the vehicle structure. A listener may obtain tactile feedback by being in touch with the vehicle structure. Such tactile feedback may be found to enhance the subjective listening experience. However, the in-vehicle speaker system may be controlled to reduce or eliminate the tactile feedback, irrespective of the volume of the audio playback. The system is also applicable to environments other than vehicles, such as cinema or home entertainment seats.

To achieve this, according to a first aspect of the present disclosure, there is provided a speaker system, in particular an in-vehicle speaker system including: at least one first low frequency speaker arranged to face in a first direction; and at least one second low frequency speaker arranged to face in a second direction, wherein the first and second speakers are mechanically coupled to a seat, in particular a vehicle seat to generate tactile feedback to a user in the seat, and wherein the first and second directions are different from one another, in particular opposite to one another, the speaker system further including a controller to control input signals, in particular input voltages of the first and second speakers relative to one another, thereby to adjust the amount of the tactile feedback.

By arranging the first and second speakers to face in opposite directions, tactile feedback can be generated that correlates with the input voltages of the first and second speakers, in particular the ratio of the input voltages.

The system can be implemented with any number of speakers. In an embodiment, the in-vehicle speaker system further includes a third speaker arranged to face in the second direction. The tactile feedback is adjustable by controlling the input voltages of the first, second and third speakers. In particular, the amount of tactile feedback is correlated with the ratio of the input voltages of the first, second and third speakers. There may be any additional number of speakers facing in the direction of the first or second speaker to provide an enhanced listening experience.

In an embodiment, the first speaker is directed toward a frontside of the seat, and the second speaker is directed toward a backside of the seat. For example, the system may be integrated in the lower seat portion of a vehicle seat and provide an immediate tactile sensation to a listener seated in the vehicle seat.

In an embodiment, the controller is configured to operate the first and second speakers with first and second input voltages, respectively. In other words, the input voltages may be controlled independently of one another, whereby the amount by which tactile feedback from the speakers cancels each other out can be controlled.

For example, the first and second input voltages may be controlled to be different from one another. If the first and second speakers have the same specification, this entails that tactile feedback from each of them does not cancel each other out. In other words, the amount of tactile feedback may be controlled by controlling the input voltage difference.

In an embodiment, the controller is configured to adjust the difference between the first and second input voltages during use of the low frequency speaker array system. In other words, the input voltage difference is not pre-set but adjustable during listening.

In an embodiment, the controller is coupled to a user interface configured to enable a user to adjust the difference between the first and second input voltages during use of the low frequency speaker array system. For example, the user interface may be integrated in an in-vehicle infotainment system which is used to adjust other audio parameters such as volume, balance, bass and treble. Thus, the present embodiment provides an additional user-adjustable parameter in terms of tactile feedback. A listener may thus adjust the system between different settings ranging from no tactile feedback to maximum tactile feedback irrespective of a volume setting and other settings.

In an example, the controller is configured to adjust the second input voltage to be lower than the first input voltage, and in particular to be half of the first input voltage. This example is particularly suited to enable some amount of tactile feedback when the first and second speakers have the same specifications.

In another example the controller is configured to adjust the first and second input voltages to be the same. In this example, if the first and second speakers have the same specifications, no tactile feedback is provided, as may be preferred by some listeners.

In an embodiment, the first and second speakers are connected to the same power source, wherein the power source is controllable to adjust the phase of the input voltage of the first speaker with respect to the phase of the input voltage of the second speaker, and in particular to invert the phase of the input voltage of the first speaker with respect to the phase of the input voltage of the second speaker. In this embodiment, the amount of tactile feedback is controllable by controlling the phases of the input voltages relative to one another. By inverting the phases, tactile feedback may be inhibited.

In an alternative embodiment, the first and second speakers are connected to different power sources. By controlling the power sources relative to one another, e.g. phases and amplitudes of the input signals, tactile feedback may be adjusted.

In an embodiment, the first and second speakers are arranged in or underneath a lower seat portion of the vehicle seat. Such arrangement enables providing immediate tactile feedback to a listener who is seated in the vehicle seat. The vehicle seat may be the driver's seat or a passenger's seat or a rear seat.

According to another aspect of the present disclosure, there is provided a speaker system, in particular the in-vehicle speaker system as described above, including an array of low frequency speakers mechanically coupled to a structure of a vehicle and facing in different directions, wherein input signals, in particular input voltages of the array of low frequency speakers are adjustable to control an amount of tactile feedback for a user who is in touch with the structure of the vehicle. Accordingly, the present in-vehicle speaker system is not only applicable to vehicle seats but may also be integrated in other parts of the vehicle that are suitable for providing tactile feedback to a listener in a vehicle, for example the interior floor or the steering wheel. Further, the system is applicable to arrays of loudspeakers, including woofers, subwoofers, and other types.

According to another aspect of the present disclosure, there is provided a seat, in particular a vehicle seat including the speaker system as described above. Accordingly, the speaker system may be provided as an integral part of a vehicle seat, for example, the lower seat portion of a vehicle seat. However, the speaker system may also be integrated in other seats, e.g., cinema or home-entertainment seats.

According to another aspect of the present disclosure, there is provided a method of providing tactile feedback in a vehicle seat having at least first and second low frequency speakers mechanically coupled to the vehicle seat and arranged to face in opposite directions, the method including: adjusting input signals, in particular voltages of the first and second speakers to be different from one another, thereby to provide tactile feedback to a listener in the vehicle seat; and adjusting the input signals to be the same, thereby to eliminate the tactile feedback to the listener.

According to this method, a listener may vary the amount of tactile feedback to accord with his/her preference by adjusting the input voltages relative to one another. This may be done independently of adjusting other audio parameters such as the volume.

### BRIEF DESCRIPTION OF THE DRAWINGS

The features, objects, and advantages of the present disclosure will become more apparent from the detailed description set forth below when taken in conjunction with the drawings in which like reference numerals refer to similar elements.

FIG. 1 schematically depicts a low frequency speaker array according to an embodiment;

FIG. 2 schematically depicts an in-vehicle low frequency speaker system coupled to a vehicle seat according to an embodiment;

FIG. 3 depicts a block diagram of a system for providing tactile feedback in a vehicle seat according to an embodiment; and

FIG. 4 depicts a flow chart of a method for providing tactile feedback in a vehicle seat according to an embodiment.

### DETAILED DESCRIPTION

The present disclosure describes a loudspeaker system including a plurality of loudspeakers arranged to face in different directions. The loudspeakers are mechanically coupled to a structure of a vehicle such as a seat to provide tactile feedback to a listener seated in the seat. Input signals of the loudspeakers may be controlled to adjust the amount of tactile feedback between zero and a maximum amount.

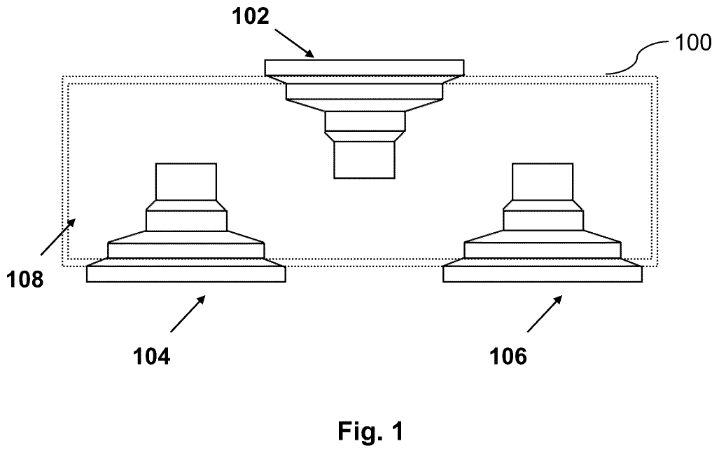

FIG. 1 schematically depicts an embodiment wherein a low frequency speaker array 100 includes three speakers 102, 104 and 106. The speakers 102, 104, 106 may be any type of loudspeakers, including woofers, subwoofers. The speaker 102 will be referred to as first speaker 102, and the speakers 104, 106 will be referred to as second speakers 104, 106.

The speakers 102, 104, 106 are mechanically coupled to each other by a frame 108. The speakers 102, 104, 106 are facing in different directions. In particular, the first speaker 102 is oriented in a first direction, and the second speakers 104,106, are oriented in a second direction. The first and second directions are opposite to one another, i.e. the axis through the center of each of the speakers extend parallel to one another. However, in alternative embodiments, speakers may be arranged such that the axis are tilted with respect to one another. In other words, the present disclosure is intended to cover implementations in which the speakers face in directions that are not exactly opposite to one another.

The speakers 102-106 may have the same specification or different specifications. For example, the first speaker 102 and second speakers 104, 106 may differ in moving mass, size, output strength, frequency, or the like. Also, all speakers facing in the same direction (for example, here: the second speakers 104, 106 facing in the second direction) may have the same specification which may be different from the specification of the speaker(s) facing in the oppositive direction (for example, here: the first speaker 102 facing in the first direction).

The embodiment of FIG. 1 includes one first speaker 102 facing in the first direction and two second speakers 104, 106 facing in the second direction. Accordingly, there number of speakers facing in one direction may be different from the number of speakers facing in the opposite direction. In this example, the ratio of speakers facing in opposite directions is 1:2. However, different ratios are possible, e.g., 1, or 1:3 or 1:4. The ratio of speakers affects the adjustment of tactile feedback, and the ratio may be selected such that a desired adjustability is obtained.

In other words, in embodiments, there may be an even or uneven distribution of the first speakers 102 and the second speakers 104, 106 to form a speaker array 100: for example, an equal amount of speakers oriented towards the first and second direction may be arranged such as two first speakers 102 and two second speakers 104, 106; or a different amount of speakers oriented towards the first and second directions may be arranged such as one first speaker 102 and two second speakers 104,106 as shown in FIG. 1, or two first speakers 102 facing the first direction and four second speakers 104, 106 facing the second direction.

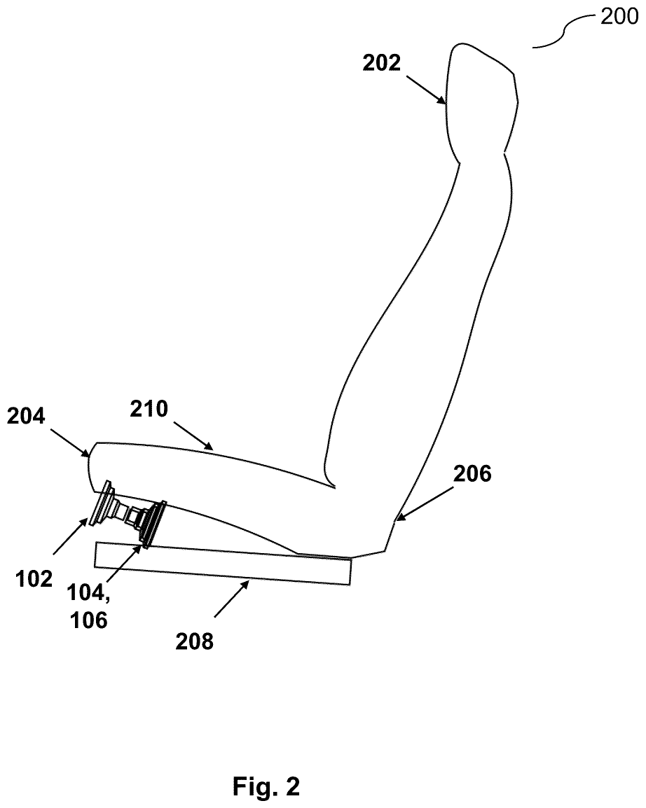

In FIG. 1, the first speaker 102 and the second speakers 104, 106 are facing in directions opposite to each other, i.e. in a “push-push” configuration. In particular, the angle between first speaker orientation and the second speaker orientation is 180°. Alternatively, the angle may vary between 150° and 180° with respect to the normal of an orientation of the speaker array 100, or, if implemented in a seat 202 of a vehicle as shown in FIG. 2, with respect to the normal of the seat orientation.

Such distributions of first speakers 102 and second speaker(s) 104, 106 enable different sound and tactile feedback distributions.

FIG. 2 schematically illustrates an in-vehicle low frequency speaker system coupled to a vehicle seat. In the illustrated embodiment, the speakers 102-106 are mechanically coupled to a seat 202 of a vehicle. Thus, vibrations of or caused by the speakers are transmitted into the seat 202. As explained in detail in the following, the speakers 102-106 generate tactile feedback correlated to an output of the speakers 102-106 within the seat 202. Thus, a listener seated in the seat 202 can perceive tactile feedback through the seat 202. This allows for a multi-sensory experience of the sound. In particular, in FIG. 2, one first speaker 102 is facing towards the front side or front edge 204 of the seat 202 and two second speakers 104, 106 are facing towards the back side, i.e. the backrest 206 of the seat 202.

The seat 202 may be a vehicle seat, in particular a driver's seat, a passenger's seat or a rear seat. The seat 202 may also be a seat 202 other than a vehicle seat such as a cinema or home cinema seat or a vehicle simulation system seat.

The first speakers 102 and second speakers 104, 106 are mechanically coupled to the seat 202 itself or other structures associated with the seat 202, for example a structure 208 through which the seat 202 is mounted in the vehicle, a structure to adjust the position of the seat 202 within the vehicle, or similar. Preferably, the speaker system 100 is coupled to a rigid structure such as a metal structure. Preferably, the speaker system 100 is positioned below a lower seat portion 210 of the seat 202 and/or below and/or within the backrest 206 of the seat 202.

The speaker array 100 may alternatively be integrated in other parts of the vehicle that are suitable for providing tactile feedback to a listener in the vehicle, for example the interior floor or the steering wheel.

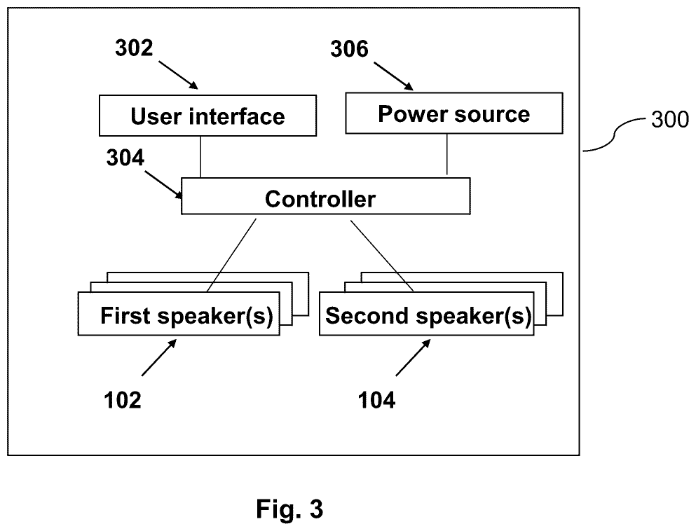

FIG. 3 shows a block diagram of a system for providing tactile feedback using the speaker array 100. The first speaker 102 and the second speakers 104, 106 are provided with input voltages from a power source 306 via a controller 304. The controller 304 allows adjusting a disbalance and difference of input voltages and/or phases of the input voltages provided to the first speaker 102 and the second speakers 104, 106, thereby to enable a tuning of the intensity of the tactile feedback.

The controller 304 is user-adjustable and configured to control the input voltages to the first speaker 102 and second speakers 104, 106, whereby the input voltages are adjustable by the listener. The controller 302 may be operable by the listener during use of the in-vehicle speaker system 100, e.g. by a user interface 302, which is communicatively coupled to the controller 304. The listener may define tactile feedback profiles and/or the listener may choose from pre-defined tactile feedback profiles. Such tactile feedback profiles may include predefined ratios between the input voltages of the first speaker 102 and the second speakers 104, 106 and correspond to predefined levels of strength of tactile feedback.

The in-vehicle speaker system 100 is operable in different modes: In a balanced mode, force cancelling occurs and impulses of the speakers 102-106 cancel each other out such that no tactile feedback or a minimum intensity tactile feedback will be perceived by the listener sitting on the seat. In a second mode, maximum tactile feedback is provided to the listener. For example, in a three-speaker arrangement as in FIG. 1, all speakers may be provided with the same voltage. Thereby, the mechanical impulses of the two second speakers 104, 106 will sum up to double the impulse of the first speaker 102 and maximum tactile feedback will be generated. Due to the mechanical coupling with the seat, the tactile feedback is perceivable by the listener. Any state “between” the two above modes can be tuned by changing or fading the input voltage difference via the controller 304. The result is a variable intensity tactile feedback that can be tuned by the listener during listening time. This can be done via a “bass immersion fader”, for example, which can be implemented as part of a user interface of an in-vehicle infotainment system.

In other words, the controller 304 may be set to level out the input voltage of the first speaker 102 and the input voltages of the second speakers 104, 106 for a minimum intensity tactile feedback. By increasing the difference between the input voltage of the first speaker 102 and the input voltages of second speakers 104, 106, the intensity of the tactile feedback is increased. Preferably, the input voltages of the second speakers 104, 106 are larger than the input voltage of the first speaker 102.

The second speakers 104, 106 may be connected to the power source 306 in a serial connection. In this example, the two second speakers 104, 106 each receive half of an amplifier output voltage as an input voltage. Provided that the first speaker 102 has the same specifications as the second speakers 104, 106, they cancel each other out and no tactile feedback is provided.

Alternatively, the second speakers 104, 106 may each be connected to separate power sources 306. Thereby, force cancelling and tuning of the input voltage difference with respect to the first speaker 102 may be controlled individually and a multi-dimensional tactile feedback distribution is enabled.

In an alternative embodiment, the phase of the input signal of the first speaker 102 may be shifted or inverted with respect to the phase of the input signal of the second speakers 104, 106. Adjusting the phases of the input signals represents another way of enabling an adjustment of tactile feedback.

In an example, the first speaker is provided with an input voltage of a first phase, and the second speakers are provided with an input voltage of a second phase. The second phase may be shifted, in particular inverted, with respect to the first phase. As vibrations of the speakers combine to form the tactile feedback, the amount or intensity of tactile feedback can be controlled by adjusting the phase difference. The maximum intensity of the tactile feedback can be increased compared to a mode in which the first and second speakers are provided with input voltages of the same phase. Thereby, a mode is enabled, in which tactile feedback can be adjusted independently from the audio output (volume) of the speakers.

In another embodiment, the first speaker 102 may have a different (e.g., lower) moving mass and/or performance compared to the second speaker 104, 106. By appropriate selection of such parameters and their ratios to one another, different arrangements of speaker arrays may be implemented while maintaining full adjustability of tactile feedback.

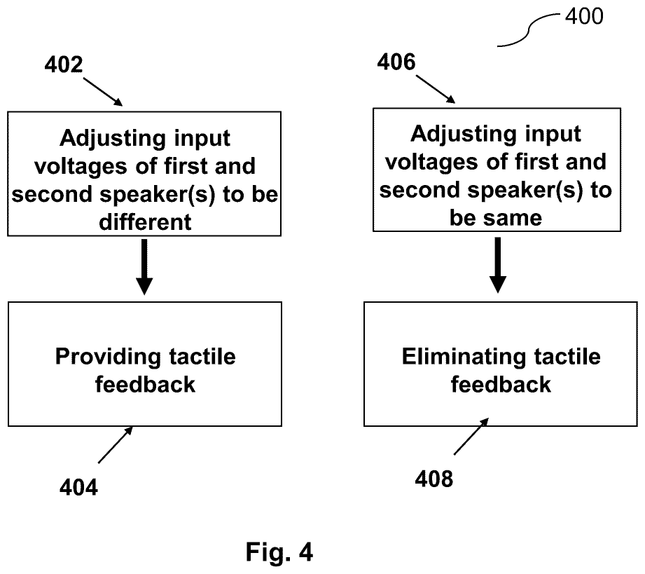

FIG. 4 depicts a flow chart of a method 400 for providing tactile feedback in a vehicle seat. The method includes adjusting the input voltages and/or phase of the input voltages of the first speaker 102 and the input voltages and/or phase of the input voltages of the second speaker 104, 106 or the. Such adjustment may include adjusting the input voltages of the first speakers 102 and the second speakers 104, 106 to be different (step 402), thereby to provide tactile feedback to the listener at a certain intensity or strength (step 404), which correlates with the input voltage ratio. The adjustment may also include adjusting the input voltages of the first speakers 102 and the second speakers 104, 106 to be the same (step 406), i.e. to cancel out each other, thereby to eliminate the tactile feedback provided to the listener (step 408).

The adjustment is controlled by the controller 304 as explained above, which in turn may be controllable by a user through a user interface. The listener may set the amount or intensity of tactile feedback via the user interface. The user interface may be part of an infotainment system of the vehicle.

What is claimed is:

1. An in-vehicle speaker system, comprising:
at least one first low frequency speaker arranged to face in a first direction;
at least one second low frequency speaker arranged to face in a second direction,
wherein the first low frequency speaker and the second low frequency speaker are mechanically coupled to a vehicle seat to generate tactile feedback to a user positioned in the vehicle seat, and
wherein the first direction and the second direction are different from one another, and
a controller configured to control input signals that correspond a first input voltage of the first low frequency speaker and a second input voltage of the second low frequency speaker to adjust the amount of the tactile feedback.

2. The in-vehicle speaker system of claim 1, further comprising a third speaker arranged to face in the second direction.

3. The in-vehicle speaker system of claim 1, wherein:
the first low frequency speaker is directed toward a frontside of the vehicle seat, and
the second low frequency speaker is directed toward a backside of the vehicle seat.

4. The in-vehicle speaker system of claim 1, wherein the controller is configured to operate the first low frequency speaker and the second low frequency speaker with first and second input voltages, respectively.

5. The in-vehicle speaker system of claim 4, wherein the first input voltage and the second input voltage are different from one another.

6. The in-vehicle speaker system of claim 5, wherein the controller is further configured to adjust a difference between the first input voltage and the second input voltage during use of a low frequency speaker array system.

7. The in-vehicle speaker system of claim 6, wherein the controller is coupled to a user interface configured to enable a user to adjust the difference the first input voltage and the second input voltage during use of the low frequency speaker array system.

8. The in-vehicle speaker system of claim 4, wherein the controller is further configured to adjust the second input voltage to be lower than the first input voltage.

9. The in-vehicle speaker system of claim 8, wherein the controller is further configured to adjust the second input voltage to be half of the first input voltage.

10. The in-vehicle speaker system of claim 4, wherein the controller is further configured to adjust the first input voltage and the second input voltage to be the same.

11. The in-vehicle speaker system of claim 1, wherein the first low frequency speaker and the second low frequency speaker are connected to the same power source, wherein the power source is controllable to adjust a phase of the first input voltage of the first low frequency speaker with respect to a phase of the second input voltage of the second low frequency speaker to invert the phase of the first input voltage of the first low frequency speaker with respect to the phase of the second input voltage of the second low frequency speaker.

12. The in-vehicle speaker system of claim 1, wherein the first low frequency speaker and the second low frequency are connected to different power sources.

13. The in-vehicle speaker system of claim 1, wherein the first low frequency speaker and the second low frequency speaker are arranged in or underneath a lower seat portion of the vehicle seat.

14. The in-vehicle speaker system of claim 1 further comprising an array of low frequency speakers mechanically coupled to a structure of a vehicle and facing in different directions, wherein array input signals that correspond to input voltages of the array of low frequency speakers are adjustable to control an amount of tactile feedback for a user who is in touch with the structure of the vehicle.

15. A method of providing tactile feedback for a vehicle seat having at least a first low frequency speaker and a second low frequency speaker mechanically coupled to the vehicle seat, wherein the first low frequency speaker and the second low frequency speaker and arranged to face one another in opposite directions, the method comprising:
adjusting a first input voltage of the first low frequency speaker and a second input voltage of second low speaker to be different from one another to provide tactile feedback for a listener in positioned in the vehicle seat; and
controlling the first input voltage and the second input voltage input signals to be the same to eliminate the tactile feedback to the listener.

16. A speaker system comprising:
at least one first low frequency speaker arranged to face in a first direction;
at least one second low frequency speaker arranged to face in a second direction,
wherein the first low frequency speaker and the second low frequency speaker are mechanically coupled to a seat to generate tactile feedback to a user positioned in the seat, and
wherein the first direction and the second direction are different from one another, and
a controller configured to control input signals that correspond a first input voltage of the first low frequency speaker and a second input voltage of the second low frequency speaker to adjust an amount of the tactile feedback.

17. The speaker system of claim 16 further comprising a third speaker arranged to face in the second direction.

18. The speaker system of claim 16, wherein:
the first low frequency speaker is directed toward a frontside of the seat, and
the second low frequency speaker is directed toward a backside of the seat.

19. The speaker system of claim 16, wherein the controller is configured to operate the first low frequency speaker and the second low frequency speaker with first and second input voltages, respectively.

20. The speaker system of claim 19, wherein the first input voltage and the second input voltage are different from one another.
